(19) United States
(12) Patent Application Publication
(10) Pub. No.: US 2003/0219358 A1
(43) Pub. Date: Nov. 27, 2003

(54) Device for embedding histological specimens in paraffin wax

(76) Inventors: Claudia Dorenkamp, Muehlhausen (DE); Stefan Kuenkel, Karlsruhe (DE); Robert Gropp, Schifferstadt (DE); Charilaos Dalkidis, Schwetzingen (DE)

Correspondence Address: GEORGE L. SNYDER, JR., Hodgson Russ LLP, Suite 2000, One M&T Plaza, Buffalo, NY, 14203-2391, US

(21) Appl. No.: 10/440,894

(22) Filed: May 19, 2003

(30) Foreign Application Priority Data
May 24, 2002 (DE) 102 23 304.7

(51) Int. Cl. B01L 3/00

(52) U.S. Cl. 422/99

(57) ABSTRACT

A device (1) for embedding specimens in paraffin wax is described. The device (1) is equipped with a pouring station (2) in which liquid paraffin wax is delivered onto the specimen. The device (1) comprises a heated working plate (3) in which an opening (4) is provided for the runoff of overflowing paraffin wax. A collection container (5) embodied as a drawer is arranged below that opening (4) for collection of the overflowing paraffin wax. A circuit arrangement (6) for signaling a filled collection container (5) is provided.

### CROSS REFERENCE TO RELATED APPLICATIONS

This application claims priority of the German patent application 102 23 304.7 filed May 24, 2002 which is incorporated by reference herein.

### FIELD OF THE INVENTION

The invention concerns a device for embedding histological specimens in paraffin wax.

### BACKGROUND OF THE INVENTION

The document entitled “LEICA EG 1140: Modulares, individuell kombinierbares Einbettsystem [Modular, individually combinable embedding system], Leica Microsystems Nussloch GmbH, February 2000, Order No. 0706-2-1101” presents a device for embedding histological specimens in paraffin wax. The unit has a pouring station for molten paraffin wax. The unit is furthermore equipped with a heated working plate. An opening is provided in the working plate so that overflowing paraffin wax can run off into a removable paraffin wax collection pan arranged therebelow.

For embedding, the specimens are arranged in commercially available cassettes. The cassettes usually have openings in the base and the cover, so the liquid paraffin wax would flow out in unimpeded fashion during embedding. To prevent this, the cassettes are retained in so-called molds.

The cassettes are filled with liquid paraffin wax using the pouring station. In this context, it is impossible to prevent paraffin wax from overflowing and soiling the heated working plate. The paraffin wax can run off from the working plate through the opening and is collected in the collection container. This collection container must then be emptied in timely fashion, since otherwise the paraffin wax would spread in unimpeded fashion within the unit and also solidify therein. An overflowing collection container can seriously damage the unit.

### SUMMARY OF THE INVENTION

It is therefore the object of the present invention to prevent overflowing of the collection container.

The invention is characterized in that a circuit arrangement for signaling filled collection containers is provided.

In an embodiment of the invention, the circuit arrangement comprises a fill level sensor, arranged in the collection container, that delivers a signal after a specified paraffin wax fill level has been reached.

In a development of the invention, the circuit arrangement comprises a timing circuit for measuring the operating time.

In an embodiment of the invention, the timing circuit delivers a corresponding signal after a specified operating time has been reached. In order to empty the collection container after a specified operating time has elapsed, it is always advantageous if the collection container is not heated, and the overflowing paraffin wax can solidify therein. This results, depending on the mode of operation, in paraffin wax blocks that would prevent accurate operation of a fill level sensor.

In a development of the invention, an optical and/or acoustic warning is triggered with the signal of the fill level sensor and/or the signal of the timing circuit. This can be accomplished with a warning lamp provided on the unit and/or a warning sound.

In an embodiment of the invention, at least one magnet is arranged in or on the collection container. A reed contact that is provided in stationary fashion on the unit is associated with this magnet.

In a development of the invention, a signal is delivered via the reed contact when the collection container is pulled out. This signal is used to cancel the optical and/or acoustic warning indicator and to restart the timing circuit for measuring the operating time.

In a development of the invention, provision is made that the working plate has several grooves for controlled runoff of the overflowing paraffin wax, and in each of these grooves at least one opening is provided for the paraffin wax to run off into the collection container arranged therebelow. The grooves channel the overflowing paraffin wax and guide it reliably into the collection container. Soiling of the working plate over a large area is thereby prevented.

In an embodiment of the invention, at least two collection containers are provided, and a separate warning indicator is associated with each collection container.

### BRIEF DESCRIPTION OF THE DRAWINGS

The invention will be depicted and explained further in an exemplary embodiment with reference to the schematic drawings, in which:

FIG. 1 is a view of the device for embedding specimens in paraffin wax; and

FIG. 2 is a view of the collection container with the magnet and reed contact.

### DETAILED DESCRIPTION OF THE INVENTION

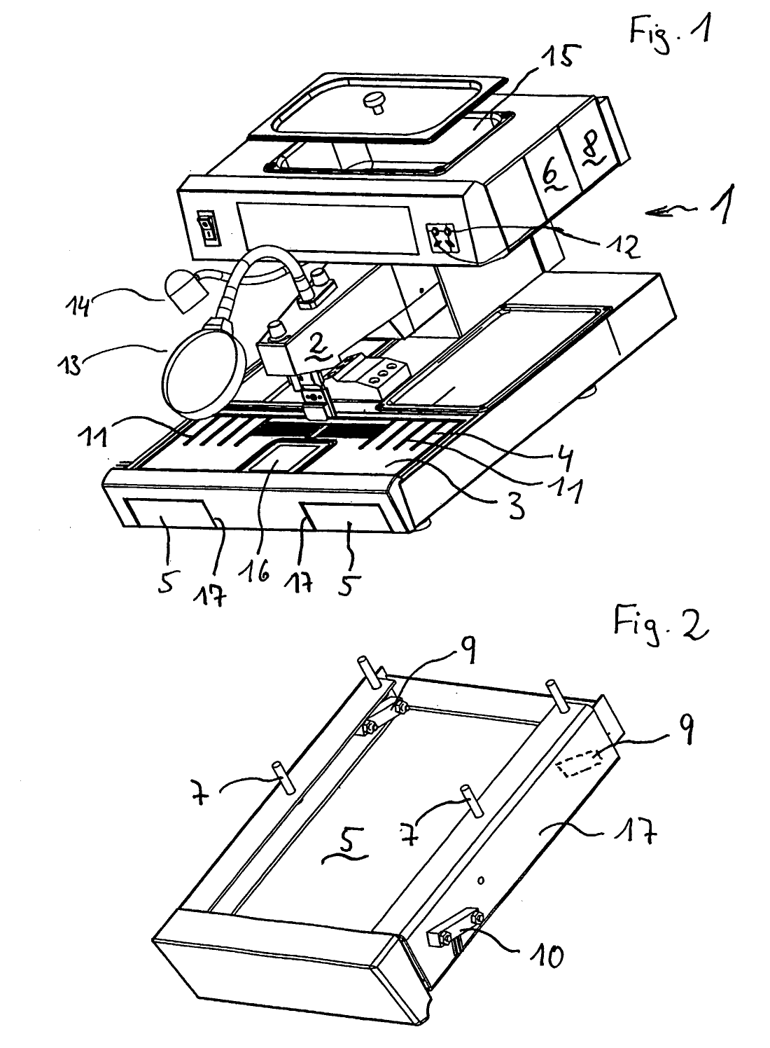

FIG. 1 is a view of device 1 for embedding specimens in paraffin wax, having a pouring station 2, a reservoir 15 for the paraffin wax, and a heated working plate 3 that has a separate cooling plate 16. A lamp 14 and a magnifier 13 are associated with the pouring station. Using the pouring station, liquid paraffin wax is delivered onto a specimen (not depicted) arranged on working plate 3. Several grooves 11, in which openings 4 are arranged, are provided in working plate 3. Overflowing paraffin wax is directed through grooves 11 and openings 4 into a collection container 5 arranged below openings 4. Collection container 5 is arranged so it can be pulled out via a drawer guide 17.

Device 1 for embedding specimens in paraffin wax has a circuit arrangement 6 comprising a timing circuit 8. Circuit arrangement 6 is electrically connected to an optical warning indicator 12. The latter is activated when a specified operating time of device 1 has been reached or exceeded via timing circuit 8. Collection container 5 must then be emptied by the user.

FIG. 2 is a view of collection container 5 with drawer guide 17 on which reed contact 10 is mounted. A magnet 9 is associated with reed contact 10 in collection container 5. Pulling out collection container 5 causes a signal to be generated via magnet 9 and reed contact 10, and forwarded to circuit arrangement 6 (FIG. 1). With this signal, an optical and/or acoustic warning signal that has occurred is shut off again.

As an alternative or in addition to magnet 9, reed contact 10, and timing circuit 8, collection container 5 can comprise a fill level sensor 7. This fill level sensor 7 is advantageously usable whenever collection container 5 is embodied in heatable fashion, and the liquid paraffin wax therefore cannot solidify.

### PARTS LIST

1 Device for embedding specimens in paraffin wax

2 Pouring station

3 Working plate

4 Opening

5 Collection container

6 Circuit arrangement

7 Fill level sensor

8 Timing circuit

9 Magnet

10 Reed contact

11 Grooves

12 Warning indicator

13 Magnifier

14 Lamp

15 Reservoir

16 Cooling plate

17 Drawer guide

What is claimed is:

1. A device (1) for embedding specimens in paraffin wax, the device comprising:
a pouring station (2) in which liquid paraffin wax is delivered onto a specimen;
a heated working plate (3) supporting the specimen, the working plate having an opening (4) through which runoff of overflowing paraffin wax flows;
a removable collection container (5) arranged below the opening (4) for collection of the overflowing paraffin wax; and
a circuit arrangement (6) for signaling when the collection container (5) is filled with paraffin wax.

2. The device (1) for embedding specimens in paraffin wax as defined in claim 1, wherein the circuit arrangement (6) comprises at least one fill level sensor (7) arranged in the collection container (5), wherein the fill level sensor (7) generates a signal when a specified fill level has been reached.

3. The device (1) for embedding specimens in paraffin wax as defined in claim 1, wherein the circuit arrangement (6) comprises a timing circuit (8) for measuring operating time of the device (1).

4. The device (1) for embedding specimens in paraffin wax as defined in claim 3, wherein the timing circuit (8) generates a corresponding signal when a specified operating time has been reached.

5. The device (1) for embedding specimens in paraffin wax as defined in claim 2, wherein an optical and/or acoustic warning is triggered with the signal.

6. The device (1) for embedding specimens in paraffin wax as defined in claim 4, wherein an optical and/or acoustic warning is triggered with the signal.

7. The device (1) for embedding specimens in paraffin wax as defined in claim 5, wherein the collection container (5) includes at least one magnet (9) and an associated reed contact (10).

8. The device (1) for embedding specimens in paraffin wax as defined in claim 6, wherein the collection container (5) includes at least one magnet (9) and an associated reed contact (10).

9. The device (1) for embedding specimens in paraffin wax as defined in claim 7, wherein a signal which cancels the optical and/or acoustic warning indicator is delivered via the reed contact (10) when the collection container (5) is removed.

10. The device (1) for embedding specimens in paraffin wax as defined in claim 8, wherein a signal which cancels the optical and/or acoustic warning indicator is delivered via the reed contact (10) when the collection container (5) is removed.

11. The device (1) for embedding specimens in paraffin wax as defined in claim 1, wherein the working plate (3) has several grooves (11) for runoff of the overflowing paraffin wax, and the working plate includes a plurality of the openings (4) in the grooves (11) for the paraffin wax to flow through to the collection container (5).

12. The device (1) for embedding specimens in paraffin wax as defined in claim 1, wherein at least two of the collection containers (5) are provided, and a separate warning indicator (12) is associated with each of the at least two collection containers (5).
